(19) United States
(12) Patent Application Publication
(10) Pub. No.: US 2023/0250227 A1
(43) Pub. Date: Aug. 10, 2023

(54) THERMOPLASTIC POLYESTER FOR PRODUCING 3D-PRINTED OBJECTS

(71) Applicant: ROQUETTE FRERES, Lestrem (FR)

(72) Inventors: Hélène AMEDRO, Bethune (FR); René SAINT-LOUP, Lomme (FR)

(21) Appl. No.: 18/004,820

(22) PCT Filed: Jun. 29, 2021
(86) PCT No.: PCT/EP2021/025241

§ 371 Date: Jan. 9, 2023

(30) Foreign Application Priority Data
Jul. 10, 2020 (FR) 2007345

(51) Int. Cl. C08G 63/672; B33Y 70/00

(52) U.S. Cl. CPC C08G 63/672; B33Y 70/00; B29K 2067/04

(57) ABSTRACT

Use of a thermoplastic polyester for producing a 3D-printed object, said polyester comprising: at least one 1,4:3,6-dianhydrohexitol unit (A); at least one butanediol unit (B); at least one terephthalic acid unit (C); wherein the ratio (A)/[(A)+(B)] is at least 0.01 and at most 0.60; said polyester being free of alicyclic diol units or comprising a molar amount of alicyclic diol units, relative to all the monomer units in the polyester, of less than 5%, and having the reduced viscosity in solution (35° C.; orthochlorophenol; 5 g/L of polyester) greater than 40 mL/g.

### TECHNICAL FIELD

The present invention relates to the field of 3D-printing and especially relates to the use of a thermoplastic polyester for producing a 3D-printed object, with said thermoplastic polyester having particularly interesting properties for this application.

### PRIOR ART

The field of 3D-printing has been booming over recent years. At the present time, 3D-printed objects may be produced from a multitude of materials such as, for example, plastic, wax, metal, plaster of Paris or even ceramics.

Despite this variety of usable materials, the choice of compounds available within each material is sometimes limited.

Relating to 3D-printed objects produced from plastic materials, not many polymers may be employed, especially for the filament coils used in some 3D-printing techniques.

At the present time, polymers such as ABS (acrylonitrile-butadiene-styrene) and PLA (polylactic acid) are the mainstays, to which polyamides and photo-resins or photo-polymers are added.

ABS is an amorphous polymer, the Tg of which changes from 100 to 115° C. in accordance with its composition and has several limitations in terms of the shaping thereof. Indeed, its use requires relatively high process temperatures of 220 to 240° C., but above all a bed temperature of 80° C. to 110° C., which requires particularly suitable instrumentation. In addition, in order to obtain large objects, the use of ABS in all cases results in visible runs and cracks on the final object due to highly pronounced shrinkage.

PLA, alone or optionally generally mixed with polyhydroxyalkanoate, is less demanding at the required temperatures and one of its main characteristics lies in its low shrinkage for 3D-printing, for this reason the use of a heating plate is not necessary when 3D-printing using the FDM (“Fused Deposition Modeling”) technique. However, its main limitation lies in a low glass transition temperature of the mixture that is of the order of 60° C.

Certain thermoplastic aromatic polyesters have thermal properties that allow them to be used directly for producing materials. They comprise aliphatic diol and aromatic diacid units. Among these aromatic polyesters, polyethylene terephthalate (PET), which is a polyester comprising ethylene glycol and terephthalic acid units, or polybutylene terephthalate (PBT), which is a polyester comprising butanediol and terephthalic acid units, may be cited.

Compared to the PET polyester, PBT has better impact resistance, in particular at low temperatures. Due to this feature, PBT plastic is considerably easier to modify than PET using fibers, with it also generally being available as a reinforced product.

In the case wherein SLS (Selective Laser Sintering) technology is used, the available polymers are also very limited. The most suitable polymers are semi-crystallines since the sintering results from a fusion/recrystallization process and allows very good cohesion of the material to be obtained. The majority of these are polyamides (PA12, PA11) and some materials such as thermoplastic polyurethanes (TPU), polyetherketone (PEK), polyetheretherketone (PEEK), polyether block amide (PEBA), etc.

### Technical Problem

However, for certain applications or under certain usage conditions, some properties need to be improved, and especially the impact resistance or even the heat resistance.

Modified PBTs have been developed by introducing 1,4:3,6-dianhydrohexitol units, especially isosorbide (PBIT), into the polyester. 1,4:3,6-dianhydrohexitols have the advantage of being able to be obtained from renewable resources such as starch.

In order to improve the impact resistance properties of the polyesters, it is known from the prior art to use polyesters, the crystallinity of which has been reduced. Therefore, the aim is to obtain polymers for which the crystallinity is eliminated by adding comonomers, and therefore, in this case, by adding 1,4-cyclohexanedimethanol.

Regarding isosorbide-based polyesters, application US2012/0177854 may be cited, which discloses polyesters comprising terephthalic acid units and diol units comprising from 1 to 60 mol % of isosorbide and from 5 to 99% of 1,4-cyclohexanedimethanol, which have improved impact resistance properties.

The use of copolyesters with improved thermal properties and necessarily including an alicyclic diol, such as CHDM, isosorbide and terephthalic acid for 3D-printing applications has been disclosed in application WO2018020192. Such a copolyester is free of ethylene glycol or any other aliphatic linear diol or contains a residual amount thereof.

Application WO 2018212596 discloses a mixture of polyesters used for producing a 3D-printing filament. This mixture is composed of a polyester A containing at least isosorbide and terephthalic acid and of a polyester B containing terephthalic acid and a diol other than isosorbide. Producing a 3D object with such a mixture would involve additional steps of homogenizing the two polyesters.

It is therefore to the applicant's credit to have found that this need for alternative plastic raw materials for use in 3D-printing could be achieved, against all expectations, with a thermoplastic polyester-based on 1,4:3,6-dianhydrohexitol units, especially isosorbide, having no or very few alicyclic diol units, especially CHDM, while to date it was known that the latter was essential for obtaining polymers with crystallinity that is reduced, or even eliminated, and which have good thermal and optical properties.

### SUMMARY OF THE INVENTION

Thus, an object of the invention is the use of a thermoplastic polyester for producing a 3D-printed object, said polyester comprising:
at least one 1,4:3,6-dianhydrohexitol unit (A);
at least one butanediol unit (B);
at least one terephthalic acid unit (C);
   wherein the ratio (A)/[(A)+(B)] is at least 0.01 and at most 0.60;
   said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g.

A second object of the invention relates to a 3D-printed object comprising the thermoplastic polyester disclosed above.

Finally, a third object relates to a method for producing a 3D-printed object from the thermoplastic polyester disclosed above, with said producing method comprising the following steps of:

a) Providing a thermoplastic polyester comprising at least one 1,4:3,6-dianhydrohexitol unit (A), at least one butanediol unit (B) other than the 1,4:3,6-dianhydrohexitol units (A), at least one terephthalic acid unit (C), wherein the ratio (A)/[(A)+(B)] is of at least 0.01 and of at most 0.60, said polyester being free of any alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g,
b) Shaping the thermoplastic polyester obtained in the preceding step,
c) 3D-printing an object from the shaped thermoplastic polyester,
d) Recovering the 3D-printed object.

The thermoplastic polyesters used according to the present invention offer excellent properties and allow 3D-printed objects to be produced.

The polymer composition integrating such a thermoplastic polyester is particularly advantageous and has improved properties. Indeed, the presence of thermoplastic polyester in the composition contributes additional properties and widens the fields of application of other polymers.

The thermoplastic polyester according to the invention thus has very good properties, especially optical and thermal properties, and is particularly suitable for use in the production of a 3D-printed object, yet without this manufacture being limited by the 3D-printing method that is used.

### DISCLOSURE OF THE INVENTION

A first object of the invention relates to the use of a thermoplastic polyester for producing a 3D-printed object, with said polyester comprising:
at least one 1,4:3,6-dianhydrohexitol unit (A);
at least one butanediol unit (B);
at least one terephthalic acid unit (C);
   wherein the ratio (A)/[(A)+(B)] is at least 0.01 and at most 0.60;
   said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g.

Said at least one butanediol unit (B) may be chosen from 1,2-butanediol, 1,3-butanediol, 1,4-butanediol or 2,3-butanediol. Preferably, said at least one butanediol unit (B) is 1,4-butanediol. In a particular embodiment, said polyester therefore comprises:
at least one 1,4:3,6-dianhydrohexitol unit (A);
at least one 1,4-butanediol (B) unit;
at least one terephthalic acid unit (C);
   wherein the ratio (A)/[(A)+(B)] is at least 0.01 and at most 0.60;
   said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g.

“Molar ratio (A)/[(A)+(B)]” is intended to mean the molar ratio of 1,4:3,6-dianhydrohexitol units (A)/sum of the 1,4:3,6-dianhydrohexitol units (A) and butanediol diol units (B).

The thermoplastic polyester is free of alicyclic diol units or comprises a small amount thereof.

“Low molar amount of alicyclic diol units” is especially intended to mean a molar amount of alicyclic diol units of less than 5%. According to the invention, this molar amount depicts the ratio of the sum of the alicyclic diol units, with these units being able to be identical or different, relative to the total number of monomer units of the polyester.

The alicyclic diol is also called aliphatic and cyclic diol. This is a diol that especially may. Highly preferentially, the alicyclic diol is 1,4-cyclohexanedimethanol. The alicyclic diol (B) may be in the cis configuration, in the trans configuration, or may be a mixture of diols in the cis and trans configurations.

The polyester may be free of alicyclic diol units or comprise a molar amount of alicyclic diol units, relative to all the monomer units of the polyester, of less than 1%, preferably, the polyester is free of alicyclic diol units.

Thus, the molar amount of alicyclic diol unit that may be chosen from 1,4-cyclohexanedimethanol, 1,2-cyclohexanedimethanol, 1,3-cyclohexanedimethanol or a mixture thereof is advantageously less than 1%. Preferably, the polyester is free of an alicyclic diol unit that may be chosen from 1,4-cyclohexanedimethanol, 1,2-cyclohexanedimethanol, 1,3-cyclohexanedimethanol or a mixture thereof. More preferentially, it is free of 1,4-cyclohexanedimethanol.

Despite the low amount of alicyclic diol, and therefore of 1,4-cyclohexanedimethanol, used for the synthesis, a thermoplastic polyester is surprisingly obtained that has a high reduced viscosity in solution and in which the amount of incorporated isosorbide may be controlled. Thus, depending on the degree of incorporation of isosorbide, it is possible to obtain amorphous or semi-crystalline copolyesters and to widen the range of properties accessible to the 3D-printed objects obtained through various producing methods, whether by filament or SLS printing.

The monomer (A) is a 1,4:3,6-dianhydrohexitol that may be isosorbide, isomannide, isoidide, or a mixture thereof. Preferably, the 1,4:3,6-dianhydrohexitol (A) is isosorbide.

“Butanediol” unit is understood to mean the diols chosen from 1,2-butanediol, 1,3-butanediol, 1,4-butanediol or 2,3-butanediol. Preferably, the butanediol unit that is employed is 1,4-butanediol.

Isosorbide, isomannide and isoidide may be obtained by dehydration of sorbitol, mannitol and iditol, respectively. Regarding isosorbide, it is sold by the Applicant under the trade name POLYSORB®.

The molar ratio of 1,4:3,6-dianhydrohexitol units (A)/sum of the 1,4:3,6-dianhydrohexitol units (A) and butanediol diol units (B), that is (A)/[(A)+(B)], is of at least 0.01 and of at most 0.60. When the molar ratio (A)/(B) is less than 0.30, the thermoplastic polyester is semi-crystalline and is characterized by the presence of a crystalline phase resulting in the presence of X-ray diffraction lines and the presence of an endothermic melting peak in differential scanning calorimetric (DSC) analysis.

Conversely, when the molar ratio (A)/[(A)+(B)] is greater than 0.30, the thermoplastic polyester is amorphous and is characterized by an absence of X-ray diffraction lines and by an absence of an endothermic melting peak in differential scanning calorimetric (DSC) analysis.

A thermoplastic polyester particularly suitable for producing a 3D-printed object comprises:
a molar amount of 1,4:3,6-dianhydrohexitol units (A) ranging from 0.5 to 33 mol %;
a molar amount of butanediol units (B) ranging from 18 to 54.5 mol %;
a molar amount of terephthalic acid units (C) ranging from 45 to 55 mol %.

Depending on the desired applications and properties regarding the 3D-printed object, the thermoplastic polyester may be a semi-crystalline thermoplastic polyester or an amorphous thermoplastic polyester.

For example, if, for certain applications, the intention is to obtain an object that may be opaque and have improved mechanical properties, the thermoplastic polyester may be semi-crystalline and thus comprises:
a molar amount of 1,4:3,6-dianhydrohexitol units (A) ranging from 0.5 to 16.5 mol %;
a molar amount of butanediol units (B) ranging from 31.5 to 54.5 mol %;
a molar amount of terephthalic acid units (C) ranging from 45 to 55 mol %.

Advantageously, when the thermoplastic polyester is semi-crystalline it has a molar ratio (A)/(B) of 0.01 to 0.30.

Conversely, when the object is intended to be transparent, the thermoplastic polyester may be amorphous and thus comprises:
a molar amount of 1,4:3,6-dianhydrohexitol units (A) ranging from 13.5 to 33 mol %;
a molar amount of butanediol units ranging from 18 to 38.5 mol %;
a molar amount of terephthalic acid units (C) ranging from 45 to 55 mol %.

Advantageously, when the thermoplastic polyester is amorphous, it has a molar ratio (A)/(B) of 0.30 to 0.60.

A person skilled in the art can readily find the analysis conditions for determining the amounts of each of the units of the thermoplastic polyester. For example, from an NMR spectrum of a poly(butylene-co-isosorbide terephtalate), the chemical shifts relating to the butanediol are comprised between 1.5 and 2.0 ppm and between 4.0 and 4.5 ppm, the chemical shifts relating to the terephthalate ring are comprised between 7.8 and 8.4 ppm and the chemical shifts relating to the isosorbide are comprised between 4.1 and 5.8 ppm. The integration of each signal allows the amount of each unit of the polyester to be determined.

The thermoplastic polyesters have a glass transition temperature ranging from 30 to 130° C., for example, from 30 to 80° C. if they are semi-crystalline and, for example, from 80° C. to 130° C. if they are amorphous.

The glass transition temperatures and melting points are measured using conventional methods, especially using differential scanning calorimetry (DSC) using a heating rate of 10° C./min. The experimental protocol is described in detail in the examples section below.

The thermoplastic polyesters used according to the invention, when they are semi-crystalline, have a melting point ranging from 165 to 225° C., for example, from 175 to 215° C.

Advantageously, when the thermoplastic polyester is semi-crystalline it has a melting heat that is greater than 20 J/g, preferably greater than 30 J/g, with measuring this melting heat consisting in subjecting a sample of this polyester to heat treatment at 170° C. for 16 hours, then assessing the melting heat using DSC by heating the sample at 10° C./min.

The thermoplastic polyester of the polymer composition according to the invention especially has a lightness L* that is greater than 45. Advantageously, the lightness L* is greater than 50, preferably greater than 55, most preferentially greater than 60, for example, greater than 62. The parameter L* may be determined using a spectrophotometer, using the CIE Lab model.

Finally, the reduced viscosity in solution of said thermoplastic polyester used according to the invention is greater than 40 mL/g and preferably less than 150 mL/g, with this viscosity being able to be measured using an Ubbelohde capillary viscometer at 35° C. in orthochlorophenol after dissolving the polymer at 130° C. under stirring, with the concentration of polymer that is introduced being 5 g/L.

This test for measuring reduced viscosity in solution is, due to the choice of solvents and the concentration of the polymers used, perfectly suitable for determining the viscosity of the viscous polymer prepared according to the method disclosed below.

Advantageously, when the thermoplastic polyester is semi-crystalline it has a reduced viscosity in solution greater than 40 mL/g and less than 150 mL/g and when the thermoplastic polyester is amorphous, it has a reduced viscosity in solution of 50 to 90 mL/g.

The semi-crystalline or amorphous nature of the thermoplastic polyesters used according to the present invention is characterized, after heat treatment for 16 hours at 170° C., by the optional presence of X-ray diffraction lines or an endothermic melting peak in differential scanning calorimetric (DSC) analysis.

Thus, when X-ray diffraction lines and an endothermic melting peak are present in the differential scanning calorimetric (DSC) analysis, the thermoplastic polyester is semi-crystalline, otherwise, it is amorphous.

According to a particular embodiment, one or several additional polymer(s) may be used in a mixture with the thermoplastic polyester for producing a 3D-object.

The additional polymer may be chosen from polyamides, photo resins, photo polymers, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The additional polymer also may be a polymer allowing the impact properties of the polyester to be improved, especially functional polyolefins such as functionalized ethylene or propylene polymers and copolymers, core-shell copolymers or block copolymers.

In particular, the 3D-printing object comprises a polymer mixture consisting of said thermoplastic polyester and one or several additional polymer(s), said mixture comprising at least 30% by weight of thermoplastic polyester relative to the total weight of said mixture, preferably said one or several additional polymer(s) being chosen from polyesters, such as polybutyl terephthalate (PBT), polylactic acid (PLA), polybutyl succinate (PBS), polybutyl succinate adipate (PBSA), polyethylene terephthalate PET, glycated polyethylene terephthalate (PETg), polycarbonates (PC), polyamides (PA), acrylonitrile butadiene styrene (ABS), thermoplastic polyurethanes (TPU), polyetheretherketone (PEEK), polyacrylates.

When an additional polymer is used, the latter may be added, for example, when shaping the thermoplastic polyester for 3D-printing or when preparing the thermoplastic polyester.

One or several additive(s) also may be added to the thermoplastic polyester when producing a 3D-printed object in order to grant it particular properties.

Thus, by way of example of additives, fillers or organic or inorganic fibers, whether or not they are on the nanometer scale, or whether or not they are functionalized, may be cited. These may be silicas, zeolites, glass beads or fibers, clays, mica, titanates, silicates, graphite, calcium carbonate, carbon nanotubes, wood fibers, carbon fibers, polymer fibers, proteins, cellulose fibers, lignocellulosic fibers, and non-destructured granular starch. These fillers or fibers may allow the hardness, the rigidity or the surface appearance of the printed parts to be improved.

The additive also may be chosen from opacifiers, dyes and pigments. They may be chosen from cobalt acetate and the following compounds: HS-325 Sandoplast® RED BB (which is a compound bearing an azo function, also known under the name of Solvent Red 195), HS-510 Sandoplast® Blue 2B, which is an anthraquinone, Polysynthren® Blue R, and Clariant® RSB Violet.

The additive also may be a UV-resistance agent such as, for example, molecules of the benzophenone or benzotriazole type, such as the Tinuvin™ range from BASF: tinuvin 326, tinuvin P or tinuvin 234, for example, or hindered amines, such as the Chimassorb™ range from BASF: Chimassorb 2020, Chimasorb 81 or Chimassorb 944, for example.

The additive also may be a fire-proofing agent or flame retardant, such as, for example, halogenated derivatives or non-halogenated flame retardants (for example, phosphorus-based derivatives such as Exolit® OP) or such as the range of melamine cyanurates (for example, Melapur™: melapur 200), or even aluminum or magnesium hydroxides.

Finally, the additive also may be an antistatic agent or even an antiblocking agent such as derivatives of hydrophobic molecules, for example, Incroslip™ or Incromol™ from Croda.

The thermoplastic polyester according to the invention is therefore used for producing a 3D-printed object.

The 3D-printed object may be produced using 3D-printing techniques that are known to a person skilled in the art.

For example, 3D-printing may be implemented by Fused Deposition Modeling (FDM) or by selective laser sintering. Preferably, 3D-printing is carried out by fused deposition modeling.

3D-printing by fused deposition modeling especially consists in extruding a yarn of thermoplastic polymer material onto a platform through a nozzle moving on the 3 axes, x, y and z. The platform descends one level to each new applied layer, until printing of the object is finished.

A person skilled in the art may thus easily adapt the shaping of the thermoplastic polyester according to the invention so that the latter may be used according to any 3D-printing method.

The thermoplastic polyester may be in the form of a yarn, of filament, of a rod, of granules, of pellets or even of powder. For example, for 3D-printing by fused deposition modeling, the thermoplastic polyester may be in the form of a rod or yarn, preferentially in the form of a yarn, before being cooled and then wound. The coil of yarn that is obtained in this way thus may be used in a 3D-printing machine for producing objects. In another example for 3D-printing by selective laser sintering, the thermoplastic polyester may be in powder form.

Preferably, when the object according to the invention is manufactured by 3D-printing by fused deposition modeling, the features used for 3D-printing may be optimized as a function of the semi-crystalline or amorphous nature of the thermoplastic polyester.

Thus, during 3D-printing by fused deposition modeling, when the thermoplastic polyester is semi-crystalline, the temperature of the printing nozzle is preferably comprised from 230° C. to 270° C. and the bed may or may not be heated with a temperature up to a maximum of 55° C. When the thermoplastic polyester is amorphous, the temperature of the printing nozzle is preferably comprised from 200° C. to 230° C. and the bed is unheated.

According to a particular embodiment, when the object is manufactured by 3D-printing by fused deposition modeling from a semi-crystalline thermoplastic polyester, said object may be recrystallized in order to make it opaque and to improve the mechanical properties, especially the impact resistance. The recrystallization may be carried out at a temperature from 80° C. to 150° C., preferably from 100° C. to 145° C., such as, for example, 140° C., for a duration of 3 to 5 hours, preferably from 3.5 to 4.5 hours, such as, 4 hours, for example.

The thermoplastic polyester as defined above has many advantages for the manufacture of a 3D-printed object.

Indeed, especially by virtue of the molar ratio of 1,4:3,6-dianhydrohexitol units (A)/sum of the 1,4:3,6-dianhydrohexitol units (A) and butanediol units (B) of at least 0.01 and a reduced viscosity in solution of more than 40 mL/g and preferably less than 120 mL/g, the thermoplastic polyesters allow 3D-printed objects to be obtained that do not creep, that do not crack and that have good mechanical properties, especially impact resistance.

More particularly, when the thermoplastic polyester is an amorphous thermoplastic polyester, it has a higher glass transition temperature than the polymers conventionally used for producing 3D-printed objects, which allows the thermal resistance of the resulting objects to be improved.

Then, when the thermoplastic polyester used for the manufacture of a 3D-printed object is a semi-crystalline thermoplastic polyester, the 3D-printed object has enough crystals to be physically solid and stable. The semi-crystalline thermoplastic polyester then advantageously has, via recrystallization by subsequent heating, the possibility of increasing its degree of crystallinity, which allows its mechanical properties, including impact resistance, to be improved.

Finally, the thermoplastic polyesters according to the invention are advantageous since they allow, when they are mixed with the usual polymers used for producing a 3D-printed object, such as a polyamide, a photo resin or a photo polymer, expanding the range of properties accessible to 3D-printed objects.

A second object of the invention relates to a method for producing a 3D-printed object, said method comprising the following steps of:

a) Providing a thermoplastic polyester as defined above,
b) Shaping the thermoplastic polyester obtained in the preceding step,
c) 3D-printing an object from the shaped thermoplastic polyester,
d) Recovering the 3D-printed object.

The shaping of step b) is adapted by a person skilled in the art as a function of the 3D-printing method implemented in step c).

The thermoplastic polyester thus may be in the form of a yarn, of filament, of a rod, of granules, of pellets or even of powder. For example, if 3D-printing is carried out by fused deposition modeling, shaping advantageously involves a yarn, and especially a coiled yarn. The coil of yarn may be obtained from extruding the thermoplastic polyester in the form of a yarn, with said yarn then being cooled and coiled.

The 3D-printing may be carried out using techniques that are known to a person skilled in the art. For example, the 3D-printing step may be carried out by fused deposition modeling.

According to an alternative, when the supplied polyester is a semi-crystalline thermoplastic polyester, the method according to the invention may further comprise an additional step e) of recrystallization. This recrystallization step especially allows the 3D-printed object to be rendered opaque and its mechanical properties, such as impact resistance, to be improved. The recrystallization step may be carried out at a temperature from 80° C. to 150° C., preferably from 100° C. to 145° C., such as, for example, 140° C., for a duration of 3 to 5 hours, preferably from 3.5 to 4.5 hours, such as 4 hours, for example.

A third object of the invention relates to a 3D-printed object manufactured with the thermoplastic polyester disclosed above. The 3D-printed object may also comprise one or more additional polymer(s), as well as one or more additive(s).

The thermoplastic polyester that is particularly suitable for obtaining a polymer composition may be prepared using a synthesis method comprising:
a step of introducing monomers into a reactor comprising at least one 1,4:3,6-dianhydrohexitols (A), at least one butanediol (B), and at least one terephthalic acid (C), with the molar ratio ((A)+(B))/(C) ranging from 1.05 to 1.5, said monomers being free of alicyclic diol or comprising, relative to all the monomers introduced, a molar amount of alicyclic diol units of less than 5%;
a step of introducing a catalytic system into the reactor;
a step of polymerizing said monomers in order to form the polyester, said step consisting in:
a first stage of oligomerization, during which the reaction medium is stirred under an inert atmosphere at a temperature ranging from 210 to 255° C., advantageously from 215 to 245° C., for example 225° C.;
a second stage of condensation of the oligomers, during which the oligomers that are formed are stirred under vacuum at a temperature ranging from 235 to 280° C., advantageously from 240 to 270° C., for example, 250° C.;
a step of recovering the thermoplastic polyester.

Said at least one butanediol (B) may be chosen from 1,2-butanediol, 1,3-butanediol, 1,4-butanediol or 2,3-butanediol. Preferably, said at least one butanediol (B) is 1,4-butanediol. In a particular embodiment, the method comprises a step of introducing monomers into a reactor comprising at least one 1,4:3,6-dianhydrohexitol (A), at least one 1,4-butanediol (B) and at least one terephthalic acid (C), with the molar ratio ((A)+(B))/(C) ranging from 1.05 to 1.5, said monomers being free of alicyclic diol or comprising, relative to all the monomers introduced, a molar amount of alicyclic diol units of less than 5%.

When the polymer is semi-crystalline, the method may further comprise:
optionally, a solid state post-condensation step
a step of crystallizing the polymer under an inert atmosphere, preferably between 80 and 150° C.,
a solid-state post-condensation step under vacuum or an inert gas stream, preferably between 150 and 220° C.

This first stage of the method is carried out in an inert atmosphere, that is, under an atmosphere of at least one inert gas. This inert gas especially may be dinitrogen. This first stage may be carried out under a gas stream, and it also may be carried out under pressure, for example, at a pressure comprised between 1.05 and 8 bar.

Preferably, the pressure ranges from 1.05 to 6 bar, most preferentially from 1.5 to 5 bar, for example, 2.5 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It may be carried out, for example, once the monomers have been introduced into the reactor, by creating a vacuum, then by introducing an inert gas such as nitrogen thereto. This vacuum-inert gas introduction cycle may be repeated several times, for example, from 3 to 5 times. Preferably, this vacuum-nitrogen cycle is carried out at a temperature between 60 and 80° C. so that the reagents, and especially the diols, are totally molten. This deoxygenation step has the advantage of improving the coloration properties of the polyester obtained at the end of the method.

The second stage of condensation of the oligomers is carried out under vacuum. The pressure may decrease continuously during this second stage by using pressure reduction gradients, in steps, or even by using a combination of pressure reduction gradients and steps. Preferably, at the end of this second stage, the pressure is less than 10 mbar, most preferentially less than 1 mbar.

The first stage of the polymerization step preferably has a duration ranging from 20 minutes to 5 hours. Advantageously, the duration of the second stage ranges from 30 minutes to 6 hours, with the beginning of this stage being the moment at which the reactor is placed under vacuum, that is, at a pressure of less than 1 bar.

The method further comprises a step of introducing a catalytic system into the reactor. This step may occur before or during the polymerization step disclosed above.

Catalytic system is intended to mean a catalyst or a mixture of catalysts, optionally dispersed or fixed on an inert support.

The catalyst is used in suitable amounts for obtaining a high-viscosity polymer for obtaining the polymer composition.

An esterification catalyst is advantageously used during the oligomerization stage. This esterification catalyst may be chosen from derivatives of tin, titanium, zirconium, hafnium, zinc, manganese, calcium, strontium, organic catalysts such as para-toluenesulfonic acid (PTSA) or methanesulfonic acid (MSA), or a mixture of these catalysts. By way of example of such compounds, those provided in application US2011282020A1, in paragraphs [0026] to [0029], and on page 5 of application WO 2013/062408 A1, may be cited.

Preferably, a zinc derivative or a manganese, tin or germanium derivative is used during the first stage of transesterification.

By way of example of amounts by weight, from 10 to 500 ppm of metal contained in the catalytic system may be used during the oligomerization stage, relative to the amount of monomers introduced.

At the end of transesterification, the catalyst from the first step may be optionally blocked by adding phosphorous acid or phosphoric acid, or even, as in the case of tin (IV), reduced with phosphites such as triphenyl phosphite or tris(nonylphenyl) phosphites or those cited in paragraph [0034] of application US2011282020A1.

The second stage of condensation of the oligomers optionally may be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may be, for example, those provided in patent EP 1882712 B1, in paragraphs [0090] to [0094].

Preferably, the catalyst is a derivative of tin, titanium, germanium, aluminum or antimony.

By way of example of amounts by weight, from 10 to 500 ppm of metal contained in the catalytic system may be used during the oligomer condensation stage, relative to the amount of monomers introduced.

Most preferentially, a catalytic system is used during the first stage and the second stage of polymerization. Said system advantageously consists of a catalyst-based on tin or of a mixture of catalysts based on tin, titanium, germanium and aluminum.

By way of example, an amount by weight from 10 to 500 ppm of metal contained in the catalytic system may be used, relative to the amount of monomers introduced.

Depending on the preparation method, an antioxidant is advantageously used during the step of polymerization of the monomers. These antioxidants allow the coloration of the obtained polyester to be reduced. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus-based compounds such as Ultranox® 626, Doverphos® S-9228, Hostanox® P-EPQ or Irgafos 168.

It is also possible to introduce, as a polymerization additive into the reactor, at least one compound that is capable of limiting unwanted etherification reactions, such as sodium acetate, tetramethylammonium hydroxide or tetraethylammonium hydroxide.

Finally, the method comprises a step of recovering the polyester on completion of the polymerization step. The thermoplastic polyester thus recovered then may be packed in a form that is easy to handle, such as pellets or granules, before being re-shaped for the requirements of 3D-printing.

According to a variant of the synthesis method, when the thermoplastic polyester is semi-crystalline, a step of increasing the molar mass may be carried out after the step of recovering the thermoplastic polyester.

The step of increasing the molar mass is carried out by post-polymerization and may consist in a step of solid-state polycondensation (SSP) of the semi-crystalline thermoplastic polyester or in a step of reactive extrusion of the semi-crystalline thermoplastic polyester in the presence of at least one chain extender.

Thus, according to a first variant of the producing method, the post-polymerization step is carried out by SSP.

SSP is generally carried out at a temperature comprised between the glass transition temperature and the melting point of the polymer. Thus, in order to carry out the SSP, the polymer needs to be semi-crystalline. Preferably, the latter has a heat of fusion greater than 20 J/g, preferably greater than 30 J/g, with the measurement of this heat of fusion consisting in subjecting a sample of this polymer with lower reduced viscosity in solution to heat treatment at 170° C. for 16 hours, then in assessing the heat of fusion using DSC by heating the sample at K/min.

Advantageously, the SSP step is carried out at a temperature ranging from 150 to 220° C., preferably ranging from 160 to 210° C., with this step imperatively having to be carried out at a temperature below the melting point of the semi-crystalline thermoplastic polyester.

The SSP step may be carried out in an inert atmosphere, for example, under nitrogen or under argon or under vacuum.

According to a second variant of the producing method, the post-polymerization step is carried out by reactive extrusion of the semi-crystalline thermoplastic polyester in the presence of at least one chain extender.

The chain extender is a compound comprising two functions capable of reacting, in reactive extrusion, with alcohol, carboxylic acid and/or carboxylic acid ester functions of the semi-crystalline thermoplastic polyester. The chain extender may be chosen, for example, from compounds comprising two isocyanate, isocyanurate, lactam, lactone, carbonate, epoxy, oxazoline and imide functions, with said functions being able to be identical or different. The chain extension of the thermoplastic polyester may be carried out in all reactors capable of mixing a highly viscous medium with stirring that is sufficiently dispersive to ensure a good interface between the molten material and the gaseous ceiling of the reactor. A reactor that is particularly suitable for this treatment step is extrusion.

The reactive extrusion may be carried out in any type of extruder, especially a single-screw extruder, a co-rotating twin-screw extruder or a counter-rotating twin-screw extruder. However, carrying out this reactive extrusion using a co-rotating extruder is preferred.

The reactive extrusion step may be carried out by:
introducing the polymer into the extruder so as to melt said polymer;
then introducing the chain extender into the molten polymer;
then reacting the polymer with the chain extender in the extruder;
then recovering the semi-crystalline thermoplastic polyester obtained in the extrusion step.

During extrusion, the temperature inside the extruder is adjusted so as to be above the melting point of the polymer. The temperature inside the extruder may range from 150 to 320° C.

The semi-crystalline thermoplastic polyester obtained after the step of increasing the molar mass is recovered and then may be packed in a form that is easy to handle, such as pellets or granules, before being re-shaped for the requirements of 3D-printing.

The invention will be better understood by means of the following examples and figures, which are intended to be purely illustrative and by no means limit the scope of protection.

### EXAMPLES

The properties of the polymers were studied using the following techniques:

Reduced Viscosity in Solution

The reduced viscosity in solution is assessed using an Ubbelohde capillary viscometer at 35° C. in orthodichlorophenol after dissolving the polymer at 130° C. under stirring, with the concentration of polymer that is introduced being 5 g/L.

DSC

The thermal properties of the polyesters were measured using differential scanning calorimetry (DSC): The sample is firstly heated under a nitrogen atmosphere in an open crucible from 10 to 300° C. (10° C.min-1), cooled to 10° C. (10° C.min-1), then re-heated to 300° C. under the same conditions as the first step. The glass transition temperatures were taken at the mid-point of the second heating step. Any melting points are determined on the endothermic peak (peak onset) in the first heating step.

Similarly, the enthalpy of fusion (area under the curve) is determined in the first heating step.

For the illustrative examples presented below, the following reagents were used:

1,4-Butanediol (Sigma Aldrich)>99%

Isosorbide (purity >99.5%) Polysorb® P from Roquette Freres

Dimethyl terephthalate (purity 99+%) from Acros

Hostanox PEPQ from Clariant

Irganox® 1010 from BASF AG (erythritol tetrakis [3-[3,5-di-tert-butyl-4-hydroxyphenyl] propionate)

Titanium tetrabutoxide (Sigma Aldrich)>97%

### Example 1: Use of a Semi-Crystalline Thermoplastic Polyester for Producing a 3D-Printed Object

A semi-crystalline thermoplastic polyester P1 is prepared for use according to the invention for 3D-printing.

A: Polymerization

10.154 kg (112.8 mol) of 1,4-butanediol, 1.826 kg (12.5 mol) of isosorbide, 18.7 kg (96.4 mol) of dimethyl terephthalate, 9.5 g of Irganox 1010 (antioxidant), 9.5 g of Hostanox PEPQ (antioxidant) and 22.59 g of titanium tetrabutoxide (catalyst) are added to a 50 L reactor. To extract the residual oxygen from the isosorbide crystals, 4 vacuum-nitrogen cycles are carried out once the temperature of the reaction medium is comprised between 60 and 80° C.

The reaction mixture is then heated to 225° C. for 105 minutes under 1.5 bar of pressure and under constant stirring (150 rpm). The degree of esterification is estimated based on the amount of distillate collected. The pressure is then reduced to 1 mbar for 60 minutes according to a logarithmic gradient and the temperature is brought to 250° C.

These low pressure and temperature conditions were maintained until the desired coupling value.

Finally, a polymer rod is cast via the bottom valve of the reactor, cooled in a heat-regulated water bath at 15° C. and chopped up in the form of granules G1 of approximately 15 mg.

Using such a method allows contact to be avoided between the heated polymer and oxygen, so as to reduce the coloration and the thermo-oxidative degradation.

The resin thus obtained has a reduced viscosity in solution of 81 mL/g.

¹H NMR analysis of the polyester P1 shows that it contains 6.4 mol % of isosorbide relative to the diols.

Regarding the thermal properties, the polyester P1 has a glass transition temperature of 49° C. and a melting point of 215° C. with an enthalpy of fusion of 45 J/g.

The granules thus obtained are subjected to a solid-state post-condensation treatment in accordance with the following protocol: 10 kg of granules of the preceding polymer are introduced into a 50 L rotavapor. The oil of the bath is then rapidly brought to 120° C. and is then gradually heated to 145° C. until optimum crystallization of the granules is obtained. This step is carried out under a nitrogen flow with a rate of 3.3 L/min. Next, the flask is heated to 205° C. under a nitrogen flow of 3.3 L/min until an IV of 120.4 mL/g is obtained.

B: Extrusion of the Granules in Order to Form a Rod

The granules G1 obtained in the preceding step are dried under vacuum at 120° C. in order to reach residual humidity levels of less than 100 ppm. For this example, the water content of the granules is 92 ppm.

The rod/yarn is extruded on a Collin extruder equipped with a two-hole die with a diameter of 2 mm each, the assembly is completed with a cooled shaper and a water cooling bath.

The extrusion parameters are consolidated in Table 1 below:

TABLE 1

| Parameters | Units | Values |
|---|---|---|
| Temperature (supply −> die): | ° C. | 230/240/250/260/260 |
| Screw rotation speed | rpm | 80 |

At the outlet of the extruder, the yarn that is obtained has a diameter of 1.75 mm. It is then surface dried after cooling with a flow of hot air at 30° C. and is then coiled.

C: Shaping of a 3D-Printed Object by Fused Deposition Modeling

The coil is installed on a Stream 20 Pro 3D-printing machine from the company Volumic.

The temperature of the nozzle is set to 260° C. and the bed is heated to 45° C.

The printed object that is obtained is a 3D polyhedron formed by several planar pentahedrons connected together by the edges.

Visual observation reveals that the produced object does not have any creep nor any cracks. In addition, the object that is obtained is transparent and also has a good surface finish.

Thus, the amorphous thermoplastic polyester according to the invention is particularly suitable for producing a printed object.

### Example 2: Use of an Amorphous Thermoplastic Polyester for Producing a 3D-Printed Object

An amorphous thermoplastic polyester P2 is prepared for use according to the invention in 3D-printing.

A: polymerization

5.64 kg (62.6 mol) of 1,4-butanediol, 9.149 kg (62.6 mol) of isosorbide, 18.7 kg (96.4 mol) of dimethyl terephthalate, 9.5 g of Irganox 1010 (antioxidant), 9.5 g of Hostanox PEPQ (antioxidant) and 29.43 g of titanium tetrabutoxide (catalyst) are added to a 50 L reactor. To extract the residual oxygen from the isosorbide crystals, 4 vacuum-nitrogen cycles are carried out once the temperature of the reaction medium is comprised between 60 and 80° C.

The reaction mixture is then heated to 225° C. for 105 minutes under 1.5 bar of pressure and under constant stirring (150 rpm). The degree of esterification is estimated based on the amount of distillate collected. The pressure is then reduced to 1 mbar for 60 minutes according to a logarithmic gradient and the temperature is brought to 250° C.

These low pressure and temperature conditions were maintained until the desired coupling value was reached.

Finally, a polymer rod is cast via the bottom valve of the reactor, cooled in a heat-regulated water bath at 15° C. and chopped up in the form of granules G2 of approximately 15 mg.

Using such a method allows contact to be avoided between the heated polymer and oxygen, so as to reduce the coloration and the thermo-oxidative degradation.

The resin thus obtained has a reduced viscosity in solution of 61 mL/g.

¹H NMR analysis of the polyester P2 shows that it contains 34.1 mol % of isosorbide relative to the diols.

With regard to the thermal properties (measured during the second heating step), the polyester P2 has a glass transition temperature of 84.1° C.

B: Extrusion of the Granules in Order to Form a Rod

The granules G2 obtained in the preceding step are dried under vacuum at 120° C. in order to achieve residual humidity levels of less than 150 ppm. For this example, the water content of the granules is 115 ppm.

The rod/yarn is extruded on a Collin extruder equipped with a two-hole die with a diameter of 2 mm each, the assembly is completed with a cooled shaper and a water cooling bath.

The extrusion parameters are consolidated in Table 2 below:

TABLE 2

| Parameters | Units | Values |
|---|---|---|
| Temperature (supply −> die): | ° C. | 210/220/230/240/240 |
| Screw rotation speed | rpm | 80 |

At the outlet of the extruder, the yarn that is obtained has a diameter of 1.75 mm. It is then surface dried after cooling with a flow of hot air at 30° C. and is then coiled.

C: Shaping of a 3D-Printed Object by Fused Deposition Modeling

The coil is installed on a Stream 20 Pro 3D-printing machine from the company Volumic.

The temperature of the nozzle is set to 230° C. and the bed is heated to 45° C.

The printed object that is obtained is a 3D polyhedron formed by several planar pentahedrons connected together by the edges.

Visual observation reveals that the produced object does not have any creep nor any cracks. In addition, the object that is obtained is transparent and also has a good surface finish.

Thus, the amorphous thermoplastic polyester according to the invention is particularly suitable for producing a printed object.

### Example 3: Use of a Semi-Crystalline Thermoplastic Polyester for Producing a 3D-Printed Object

A semi-crystalline thermoplastic polyester P3 is prepared for use according to the invention in 3D-printing.

A: Polymerization

7.89 kg (87.7 mol) of 1,4-butanediol, 5.49 kg (37.59 mol) of isosorbide, 18.7 kg (96.4 mol) of dimethyl terephthalate, 9.5 g of Irganox 1010 (antioxidant), 9.5 g of Hostanox PEPQ (antioxidant) and 29.43 g of titanium tetrabutoxide (catalyst) are added to a 50 L reactor. To extract the residual oxygen from the isosorbide crystals, 4 vacuum-nitrogen cycles are carried out once the temperature of the reaction medium is comprised between 60 and 80° C.

The reaction mixture is then heated to 225° C. for 105 minutes under 1.5 bar of pressure and under constant stirring (150 rpm). The degree of esterification is estimated based on the amount of distillate collected. The pressure is then reduced to 1 mbar for 60 minutes according to a logarithmic gradient and the temperature is brought to 250° C.

These low pressure and temperature conditions were maintained until the desired coupling value.

Finally, a polymer rod is cast via the bottom valve of the reactor, cooled in a heat-regulated water bath at 15° C. and chopped up in the form of granules G3 of approximately 15 mg.

Using such a method allows contact to be avoided between the heated polymer and oxygen, so as to reduce the coloration and the thermo-oxidative degradation.

The resin thus obtained has a reduced viscosity in solution of 66 mL/g.

¹H NMR analysis of the polyester P3 shows that it contains 21 mol % of isosorbide relative to the diols.

With regard to the thermal properties (measured during the second heating step), the polyester P3 has a glass transition temperature of 66° C., a melting point of 185° C. and a crystallization temperature of 109° C.

The granules thus obtained are subjected to a solid-state post-condensation treatment in accordance with the following protocol: 10 kg of granules of the preceding polymer are introduced into a 50 L rotavapor. The oil of the bath is then rapidly brought to 120° C. and is then gradually heated to 145° C. until optimum crystallization of the granules is obtained. This step is carried out under a nitrogen flow with a rate of 3.3 L/min. Next, the flask is heated to 175° C. under a nitrogen flow of 3.3 L/min until an IV of 75 mL/g is obtained.

B: Producing a 3D-Printed Object Using SLS

Crushing is carried out with a cryo-crusher in order to reach a particle size comprised between 50 μm and 100 μm.

The printer that is used is the SnowWhite model by Sharebot.

The temperature of the chamber was set to 100° C. for the chamber and 150° C. for the surface (powder bed).

The laser power was 8 W and the scanning speed was 800 mm/s. When the laser passes, the material completely melts and the cohesion between the layers is very good.

The parts thus obtained have excellent impact resistance and excellent dimensional stability.

### Example 4: Mechanical Properties of Amorphous and Semi-Crystalline Thermoplastic Polyesters for Producing a 3D-Printed Object

The mechanical properties of polyesters free of isosorbide or containing 4 mol % and 21 mol %, respectively, of isosorbide relative to the diols were assessed. Charpy impact values at 23° C. and −30° C. were assessed and are consolidated in Table 3 below. These tests were carried out using a pendulum block from the CEAST line, model 9050 in accordance with standard ISO 179.

TABLE 3

| | Charpy impact | Charpy impact |
|---|---|---|
| | (notched bars) | (notched bars) |
| Sample | at 23° C. - kJ/m² | A cold (−30° C.) - kJ/m² |
| Polybutylene terephthalate | 4 | 3 |
| (PBT) | | |
| Poly(butylene-co- | 5 | 4 |
| isosorbide) terephthalate | | |
| containing 4 mol % of | | |
| isosorbide relative to the | | |
| diols (PBI4T) | | |
| Poly(butylene-co- | 160 | 13 |
| isosorbide) terephthalate | | |
| containing 21 mol % of | | |
| isosorbide relative to the | | |
| diols (PBI21T) | | |

### Example 5: Thermal Properties of Amorphous and Semi-Crystalline Thermoplastic Polyesters for Producing a 3D-Printed Object

The thermal properties of polyesters containing 4 mol %, 6 mol %, 13 mol % and 21 mol %, respectively, of isosorbide relative to the diols were assessed using DSC. The glass transition temperatures (Tg), crystallization temperatures (Tc) and melting points temperatures were analyzed and are consolidated in Table 4 below.

TABLE 4

| Sample | Tg (° C.) | Tc (° C.) | Tm (° C.) |
|---|---|---|---|
| PBI4T | 47 | 162 | 220 |
| PBI6T | 49 | 163 | 220 |
| PBI13T | 58 | 113 | 200 |
| PBI21T | 61 | 109 | 185 |

The crystallization temperature is measured using DSC during cooling, since after the powder is melted by the laser, the material cools and the crystallization allows good cohesion to be provided for the part.

In the case of printing using the technique of fused deposition modeling, the materials used may be amorphous or semi-crystalline.

In the case of printing using the selective laser sintering (SLS) technique, the materials used must be semi-crystalline and available in powder form. Furthermore, the melting points and the crystallization temperatures must not be too high insofar as the machines that are used generally operate at a temperature of less than 200° C. The two crystallization and melting peaks must be very distinct in order to have a wide enough sintering window. Thus, the PBITs are adapted to this technology.

1. Use of a thermoplastic polyester for producing a 3D-printed object, said polyester comprising:
at least one 1,4:3,6-dianhydrohexitol unit (A);
at least one butanediol unit (B);
at least one terephthalic acid unit (C);
wherein the ratio (A)/[(A)+(B)] is at least 0.01 and at most 0.60;
said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g.

2. A 3D-printed object comprising a thermoplastic polyester comprising:
at least one 1,4:3,6-dianhydrohexitol unit (A);
at least one butanediol unit (B);
at least one terephthalic acid unit (C);
wherein the (A)/[(A)+(B)] is at least 0.01 and of at most 0.60;
said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g.

3. A method for producing a 3D-printed object comprising the following steps of:
a) providing a thermoplastic polyester comprising at least one 1,4:3,6-dianhydrohexitol unit (A), at least one butanediol unit (B) other than the 1,4:3,6-dianhydrohexitol units (A), at least one terephthalic acid unit (C), wherein the ratio (A)/[(A)+(B)] is of at least 0.01 and of at most 0.60, said polyester being free of any alicyclic diol units or comprising a molar amount of alicyclic diol units, relative to all the monomer units of the polyester, of less than 5%, and the reduced viscosity in solution of which (35° C.; phenol (50% m): ortho-dichlorobenzene (50% m); 5 g/L of polyester) is greater than 40 mL/g,
b) shaping the thermoplastic polyester obtained in the preceding step,
c) 3D-printing an object from the shaped thermoplastic polyester,
d) recovering the 3D-printed object.

4. The producing method according to claim 3, wherein in step b) the thermoplastic polyester is in the form of a yarn, of filament, of a rod, of granules, of pellets or of powder.

5. The method according to claim 3 wherein the 3D-printing step c) is carried out using the fused deposition modeling technique or using the selective laser sintering technique.

6. The use according to claim 1, wherein the 1,4:3,6-dianhydrohexitol (A) is isosorbide.

7. The use according to claim 1 wherein the polyester is free of alicyclic diol units or comprises a molar amount of alicyclic diol units, relative to all the monomeric units of the polyester, of less than 1%, preferably the polyester is free of alicyclic diol units.

8. The use according to claim 7, wherein the polyester is free of 1,4-cyclohexanedimethanol, 1,2-cyclohexanedimethanol, 1,3-cyclohexanedimethanol or a mixture of these diols.

9. The use according to claim 1 wherein the molar ratio (3,6-dianhydrohexitol unit (A)+butanediol unit (B))/(terephthalic acid unit (C)) is from 1.05 to 1.5.

10. The use according to claim 1, the 3D-printed object according to one of claims 2 and 6 to 9, or the producing method according to one of claims 3 to 9, wherein the 3D-printed object comprises one or several additive(s).

11. The use according to claim 1, a 3D-printed object comprising a thermoplastic polyester comprising:
at least one 1,4:3,6-dianhydrohexitol unit (A);
at least one butanediol unit (B);
at least one terephthalic acid unit (C);
wherein the (A)/[(A)+(B)] is at least 0.01 and of at most 0.60;
said polyester being free of alicyclic diol units or comprising a molar amount of alicyclic diol units, relative to all the monomer units of the polyester, of less than 5%, and the reduced viscosity in solution of which (35° C.; orthochlorophenol; 5 g/L of polyester) is greater than 40 mL/g, wherein the 3D-printed object comprises a polymer mixture consisting of said thermoplastic polyester and one or several additional polymer(s), said mixture comprising at least 30% by weight of thermoplastic polyester relative to the total weight of said mixture, preferably said one or several additional polymer(s) being chosen from polyesters, such as polybutyl terephthalate (PBT), polylactic acid (PLA), polybutyl succinate (PBS), polybutyl succinate adipate (PBSA), polyethylene terephthalate PET, glycated polyethylene terephthalate (PETg), polycarbonates (PC), polyamides (PA), acrylonitrile butadiene styrene (ABS), thermoplastic polyurethanes (TPU), polyetheretherketone(PEEK), polyacrylates.
